(19) United States
(12) Patent Application Publication
(10) Pub. No.: US 2022/0200167 A1
(43) Pub. Date: Jun. 23, 2022

(54) CIRCULARLY POLARIZED ANTENNA

(71) Applicant: Carrier Corporation, Palm Beach Gardens, FL (US)

(72) Inventors: Marat Patotski, Gdañsk (PL); Michael Ramoutar, Westford, MA (US)

(21) Appl. No.: 17/554,440

(22) Filed: Dec. 17, 2021

(30) Foreign Application Priority Data
Dec. 22, 2020 (EP) 20275189.7

(51) Int. Cl. H01Q 21/24; H01Q 9/04

(52) U.S. Cl. CPC H01Q 21/245; H01Q 9/0421

(57) ABSTRACT

An elliptically or circularly polarized microstrip antenna. The antenna includes a substrate, a conductor arranged on a first side of the substrate, and a ground plane. The conductor includes a first antenna extending generally in a first direction, and a second antenna extending generally in a second direction, wherein the second direction is orthogonal to the first direction. The second antenna is connected to the ground plane via one or more electrical components including one or more resistors, one or more inductors and/or one or more capacitors.

### FOREIGN PRIORITY

This application claims priority to European Patent Application No. 20275189.7, filed Dec. 22, 2020, and all the benefits accruing therefrom under 35 U.S.C. § 119, the contents of which in its entirety are herein incorporated by reference.

### TECHNICAL FIELD

The present disclosure relates to an antenna configured to emit and/or receive elliptically or circularly polarized radiation.

### BACKGROUND

Antennas that are configured to emit and/or receive circularly polarized radiation (“circularly polarized antennas”) are widely used in various applications such as wireless communications, Internet of Things (IoT) devices, Global Position System (GPS) device, and so on. Circularly polarized antennas can beneficially be used to provide positioning and polarization diversity.

Common circularly polarized antennas include patch antennas, helical antennas, and spiral antennas. However, known antennas can take up relatively large amounts of space, which might be inappropriate e.g. for miniature and handheld applications.

It is known to construct a circularly polarized antenna from a combination of two monopole antennas oriented at 90° to one another. For example, CN 109546320B discloses a circularly polarized antenna constructed from an inverted-F antenna 4 and a monopole antenna 3.

The Applicant believes that there remains scope for improvements to circularly polarized antennas.

### SUMMARY

The present disclosure provides a microstrip antenna configured to emit and/or receive elliptically or circularly polarized radiation, the microstrip antenna comprising: a substrate; a conductor arranged on a first side of the substrate; and a ground plane; wherein the conductor comprises a first antenna extending generally in a first direction, and a second antenna extending generally in a second direction, wherein the second direction is orthogonal to the first direction; and wherein the second antenna is connected to the ground plane via one or more electrical components comprising one or more resistors, one or more inductors and/or one or more capacitors.

Connecting the second antenna to the ground plane via one or more electrical components provides additional control and flexibility in the design of the antenna. In other words, the antenna of various embodiments has one or more additional degrees of freedom (i.e. in addition to geometric degrees of freedom) in its design. In particular embodiments, the electrical components are selected so as to control the amplitude and/or phase balance between the first antenna and the second antenna. This in turn allows simultaneous control of the axial ratio, the antenna gain and the input impedance of the antenna.

The antenna is a microstrip antenna, i.e. an antenna formed from a substrate, a conductor arranged on a first side of the substrate, and a ground plane.

A microstrip is a type of transmission line, e.g. which may be used for the transmission of microwave, terahertz, or high frequency radio waves. Microstrip structures may be fabricated on printed circuit board (PCB) or as part of monolithic microwave integrated circuits (MMICs) using conventional methods known to the skilled person. Such methods include, but are not limited to, milling, screen printing, and chemical etching. Thus, the microstrip antenna may be formed on a PCB by one of those techniques.

The substrate may comprise a (single) layer of substrate material, e.g. where the material may have a thickness of around 1.0 mm or less. The substrate may be formed from an electrically insulting material. Suitable substrate materials include, for example, Duroid, Teflon and FR4.

The conductor may comprise an electrically conducting layer formed on a first side of the substrate. The conductor may be arranged directly on (i.e. contacting) the first side of the substrate, or indirectly on the first side of the substrate (e.g. where one or more layers are provided between the conductor and the substrate). The conducting layer may be relatively thin compared to the thickness of the substrate. For example, the conducting layer may have a thickness of around 0.1 mm. 0.05 mm, or less. The conducting layer may have a uniform thickness. Suitable conductor materials are metals such as, for example, copper.

A microstrip structure may be formed in the conducting layer. The microstrip structure may have a two-dimensional shape in the plane of the conducting layer, e.g. formed by etching or milling the conducting layer to remove unwanted conducting material.

The ground plane may comprise a part of the conducting layer that has a relatively large area compared to the combined area of the antennas. Additionally or alternatively, the ground plane may comprise a ground layer formed on the opposite side of the substrate to the conducting layer. Such a ground layer may cover most of the substrate on the side on which it is placed, but should not cover the area (directly) beneath the first and second antennas.

The ground plane and/or ground layer may be formed from an electrically conductive material such as the same conducting material as the conducting layer. The ground plane and/or ground layer may have a uniform thickness. The conductor (e.g. the ground plane in the conductor) may be connected to the ground layer by one or more vias. A via is an electrical connection between the conducting layer on one side of the substrate and the ground layer on the other side of the substrate, and may be a through hole where the edges of the hole are coated in a conducting material.

The conductor comprises a first antenna extending generally in a first (x) direction, and a second antenna extending generally in a second (y) direction, wherein the second (y) direction is orthogonal to the first (x) direction. That is, the conducting layer may be formed (e.g. etched or milled) into first and second orthogonal antennas.

The first (x) and second (y) directions may be directions in the plane of the conducting layer, i.e. parallel to the plane of the substrate. A third (z) direction may be defined as the direction orthogonal to the plane of the substrate and/or the plane of the conducting layer (i.e. orthogonal to both the first (x) and second (y) directions).

The first and second antennas may each be a microstrip antenna. Thus, the microstrip antenna may comprise two orthogonal microstrip antennas.

Each of the first and second antennas may comprise at least a monopole section, e.g. the first antenna may comprise a first monopole section extending along the first (x) direction, and the second antenna may comprise a second monopole section extending along the second (y) direction. Each monopole section may, for example, comprise a microstrip having a length of λg/4, where λg is the wavelength in the substrate of the radiation that the antenna is designed to emit and/or receive. Thus, the first monopole section may have a length of λg/4 in the first (x) direction, and the second monopole section may have a length of λg/4 in the second (y) direction.

Each of the first and second antennas may comprise any suitable type of microstrip antenna, such as an inverted L-antenna or an inverted F-antenna.

An inverted L-antenna comprises a monopole section connected to the ground plane via a (single) microstrip section at one extreme (end) of the monopole section. An inverted F-antenna comprises a monopole section connected to the ground plane via a (single) microstrip section at one extreme (end) of the monopole section, and a feeding microstrip section, one (a first) end of which is connected to an intermediate region of the monopole section, e.g. connected to a point on the monopole section that is closer to the grounded end than it is to the central point of (the length of) the monopole section, and the other (second) end of which is an antenna input, which may be connected to a transmitter or a receiver.

In various particular embodiments, the first antenna is an inverted F-antenna. Thus, the first antenna may comprise a first monopole section arranged along the first (x) direction, where the first monopole section is connected to the ground plane via a (single) microstrip section, which may extend along the second (y) direction (so as to form a gap between the first monopole section and the ground plane in the second (y) direction). The first antenna may also comprise a feeding microstrip line, which may comprise an antenna input port, which may be connected to an intermediate region of the monopole section, and which may extend along the second (y) direction.

Thus, a first microstrip section may be connected to one extreme (end) of the first monopole section, and a second feeding microstrip section may be connected to an intermediate region of the first monopole section, e.g. connected to a point on the first monopole section that is closer to the grounded end than it is to the central point of (the length of) the first monopole section. The first and second microstrip sections of the first antenna may be parallel and may have equal lengths (in the second (y) direction).

In various particular embodiments, the second antenna is an inverted L-antenna. Thus, the second antenna may comprise a second monopole section arranged along the second (y) direction, where the second monopole section is connected to the ground plane via a (single) microstrip section at one extreme (end) of the second monopole section.

At least part of the microstrip section of the second antenna should extend along the first (x) direction (so as to form a gap between the second monopole section and the ground plane in the first (x) direction). In some embodiments, part of the microstrip section of the second antenna may also extend along the second (y) direction. For example, the second monopole section of the second antenna may be connected to the ground plane via an “L”-shaped microstrip section, comprising a first microstrip line section extending in the first (x) direction connected in series with a second microstrip line section extending in the second (y) direction.

Other embodiments would, however, be possible.

In embodiments, the (whole) antenna is fed via an (single) input provided on the feeding microstrip section of the first antenna.

The (first monopole section of the) first antenna may be configured to emit and/or receive electromagnetic radiation that is linearly polarized in the second (y) direction, and the (second monopole section of the) second antenna may be configured to emit and/or receive electromagnetic radiation that is linearly polarized in the first orthogonal (x) direction.

Where the amplitudes of the radiation emitted by/received by each of the antennas is equal, and where there is a phase difference of 90° between the radiation emitted by/received by each of the antennas (i.e. where the amplitude and phase are balanced between the first and second antennas), the combined emitted/received radiation will be “perfectly” circularly polarized. Where one or both of the amplitude and phase are not perfectly balanced (but where both amplitudes are non-zero and there is a non-zero phase difference), the emitted/received radiation will be elliptically polarized.

The polarization nature of circularly/elliptically polarized radiation can be described by the so-called axial ratio (AR). The axial ratio is defined as the ratio between the minor and major axis of the polarization ellipse. If the ellipse has equal minor and major axes, the antenna is “perfectly” circularly polarized, and the axial ratio is equal to one. The axial ratio of a linearly polarized antenna is infinitely big since the minor axis is equal to zero. For a circularly polarized antenna, it is desirable for the axial ratio to be as close to 1 as possible.

The geometric dimensions of a microstrip antenna design are commonly adjusted to fulfill one or more desired conditions for the antenna. For example, the geometric dimensions may be adjusted to obtain a desired axial ratio, antenna gain and/or input impedance. However, the Applicant has recognized that there can be a trade-off between two or more of these conditions, and in particular that known designs do not allow simultaneous optimization of the axial ratio, the antenna gain and the input impedance.

Thus, in accordance with the invention, the second antenna is connected to the ground plane via one or more electrical components comprising one or more resistors, one or more inductors and/or one or more capacitors.

Connecting the second antenna to the ground plane via one or more electrical components provides additional control and flexibility in the design of the antenna. In other words, connecting the second antenna to the ground plane via one or more electrical components provides one or more additional degrees of freedom (i.e. in addition to geometric considerations) in the design of the antenna.

In particular embodiments, the one or more components are selected to control the amplitude and/or phase balance between the first antenna and the second antenna. This in turn allows simultaneous control of the axial ratio, antenna gain and the input impedance of the antenna.

The one or more electrical components should be understood as being distinct from (not the same as) one or more microstrip sections. In particular embodiments, each electrical component comprises a surface mounted component such as a Surface Mounted Device (SMD) or Surface Mount Technology (SMT) component. The Applicant has recognised that these devices are particularly suited for integration with microstrip antennas.

The one or more electrical components may be connected in series between the second monopole section of the second antenna and the ground plane. For example, the one or more electrical components may be connected in series with the microstrip section of the second antenna that connects the second monopole section to the ground plane. Thus, the (second monopole of the) second antenna may be connected to the ground plane via the one or more electrical components and a microstrip section connected in series.

Where, as described above, the second monopole section of the second antenna is connected to the ground plane via an “L”-shaped microstrip section, the one or more electrical components may be connected in series between the first microstrip line section that extends in the first (x) direction and the second microstrip line section that extends in the second (y) direction. Other arrangements would, however, be possible.

In various particular embodiments, the one or more electrical components form a phase shift circuit. That is, the one or more electrical components may be configured to introduce a phase shift between the (radiation emitted by/received by the) first and second antennas. The one or more electrical components may be configured so that the antenna provides a phase difference of approximately 90° between the radiation emitted by/received by the first and second antennas.

Such a phase shift may be provided by a circuit that provides a resistance and a reactance (i.e. a complex impedance). Such a phase shift circuit can be formed by connecting one or more resistors in series with one or more inductors and/or one or more capacitors.

Thus, in particular embodiments, the one or more electrical components comprise one or more resistors connected in series with one or more inductors and/or one or more capacitors. For example, the one or more electrical components may comprise a resistor connected in series with an inductor, or a resistor connected in series with a capacitor. Other arrangements would, however, be possible.

As described above, the one or more electrical components provide one or more additional degrees of freedom in addition to geometric degrees of freedom in the design of the antenna.

Thus, for example, the geometry of the antenna may be configured to achieve amplitude balance between the first and second antennas (i.e. so that the amplitudes of the radiation emitted by/received by each of the antennas are approximately equal). This may be achieved, e.g. by appropriately adjusting the length(s) of the first and/or second antenna(s), the size of the gap(s) between the first and/or second antenna(s) and the ground plane, and/or the length of the second microstrip line section, and so on.

The phase balance may then be adjusted using the phase-shift circuit that is configured to introduce a phase shift. Such a phase shift circuit can introduce a fixed phase shift over a wide frequency range. This in turn allows simultaneous control of the axial ratio, antenna gain and the input impedance of the antenna.

### BRIEF DESCRIPTION OF THE DRAWINGS

Certain preferred embodiments of the present invention will now be described, by way of example only, with reference to the following drawings, in which:

FIG. 1 shows schematically an antenna configured in accordance with an embodiment;

FIG. 2 shows schematically an antenna configured in accordance with an embodiment;

FIG. 3 illustrates schematically circularly polarized radiation;

FIG. 4 illustrates schematically an equivalent circuit of a phase shift circuit configured in accordance with an embodiment;

FIG. 5 illustrates schematically of a phase shift circuit configured in accordance with an embodiment; and

FIG. 6A illustrates the far field pattern; and

FIG. 6B illustrates the axial ratio (AR) of an antenna configured in accordance with an embodiment.

### DETAILED DESCRIPTION

Antennas that are configured to emit and/or receive circularly polarized radiation (“circularly polarized antennas”) are widely used in various applications such as wireless communications, Internet of Things (IoT) devices, Global Position System (GPS) device, and so on. Circularly polarized antennas can beneficially be used to provide positioning and polarization diversity. It can be desirable to provide a compact circularly polarized antenna, e.g. for miniature and handheld applications.

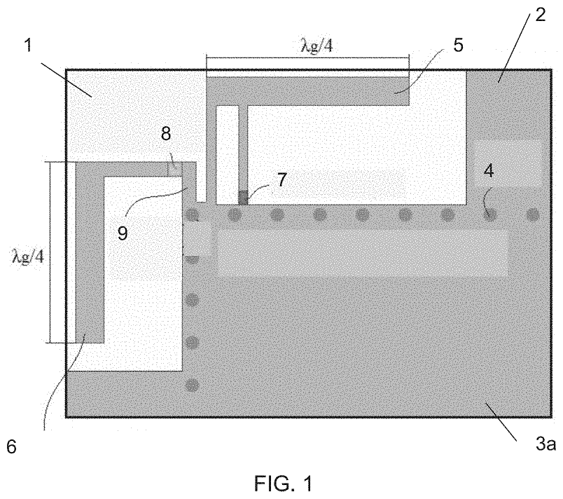

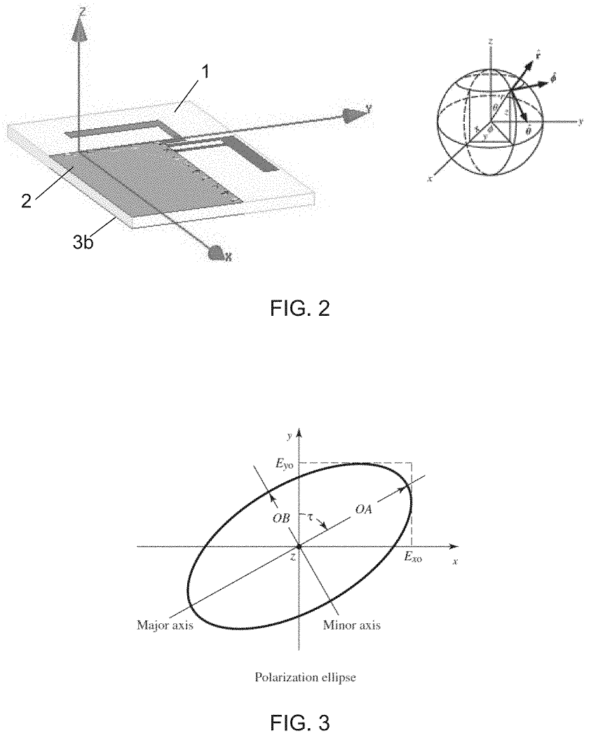

FIGS. 1 and 2 illustrate a microstrip antenna in accordance with various embodiments that is configured to emit and/or receive circularly polarized radiation.

The antenna is a microstrip antenna, and so is formed from a substrate 1, an electrically conducting layer 2 arranged on one side of the substrate, and a ground layer 3b arranged on the opposite side of the substrate.

The substrate 1 may comprise a layer of electrically insulting material such as, for example, Duroid, Teflon or FR4. The conducting layer 2 may comprise a thin layer of a metal such as copper, and may have a uniform thickness.

A microstrip structure may be fabricated on printed circuit board (PCB) or as part of monolithic microwave integrated circuits (MMICs) using conventional methods known to the skilled person such as milling, screen printing, and chemical etching. A desired two-dimensional shape may be formed in the conducting layer 2, e.g. by etching or milling the conducting layer to remove unwanted conducting material.

The ground layer 3b comprises another layer of electrically conductive material (e.g. copper) formed on the opposite side of the substrate 1 to the conducting layer 2. The ground layer 3b may cover most of the substrate 1 on the side on which it is placed. The ground layer 3b should not cover the area directly beneath the first 5 and second 6 antennas.

As illustrated in FIGS. 1 and 2, a ground plane 3a in the conducting layer 2 is connected to the ground layer 3b by vias 4, i.e. electrical connections between the conducting layer 2 and the ground layer 3b in the form of through holes where the edges of the holes are coated in an electrically conducting material.

As illustrated in FIGS. 1 and 2, the conducting layer 2 is formed (e.g. etched or milled) into a shape that comprises a first microstrip antenna 5 extending generally in a first (x) direction, and a second microstrip antenna 6 extending generally in a second orthogonal (y) direction. A third (z) direction may be defined as the direction orthogonal to the plane of the substrate 1 and/or the plane of the conducting layer 2 (and so orthogonal to the first (x) and second (y) directions).

More specifically, in the present embodiment, the first microstrip antenna 5 is an inverted F-antenna, i.e. comprising a λ_{g/4} length monopole section extending in the first (x) direction, and being connected to the ground plane 3a a single microstrip section which is connected to one end of the monopole section. The inverted F antenna 5 also comprises an intermediate feeding microstrip section which is connected to an intermediate region of the monopole section. The whole antenna is fed via an input 7 provided on the intermediate feeding microstrip section.

The second microstrip antenna 6 is an inverted L-antenna, i.e. comprising a λ_{g}/4 length monopole section extending in the second (y) direction, and being connected to the ground plane via a single microstrip section at one end of the monopole section.

As shown in FIG. 1, the monopole section of the second antenna 6 is connected to the ground plane 3a via an “L”-shaped microstrip section. Thus, the monopole section of the second antenna 6 is connected to the ground plane 3a via a first microstrip line section extending in the first (x) direction and an additional microstrip line section 9 that extends in the second (y) direction.

As is also illustrated in FIG. 1, the second antenna 6 is connected to the ground plane 3a via one or more electrical components 8 connected in series between a portion of the microstrip line section and the monopole section of the second antenna 6. The electrical components 8 comprise one or more resistors, one or more inductors and/or one or more capacitors.

Connecting the second antenna to the ground plane via one or more electrical components provides additional control and flexibility in the design of the antenna. In other words, the antenna of various embodiments has one or more additional degrees of freedom in addition to geometric degrees of freedom in its design.

The inverted F-antenna 5 is configured to emit and/or receive electromagnetic radiation that is linearly polarized in the second (y) direction, and the inverted L-antenna 6 is configured to emit and/or receive electromagnetic radiation that is linearly polarized in the first orthogonal (x) direction. Where the amplitudes of radiation emitted by/received by each of the antennas are equal, and where the phase difference between the radiation emitted by/received by the first 5 and second 6 antennas is 90° (i.e. where the amplitude and phase are balanced between the first 5 and second 6 antennas), the emitted/received radiation will be “perfectly” circularly polarized. Where, on the other hand, one or both of the amplitude and phase are not perfectly balanced, the emitted/received radiation will be elliptically polarized.

The electric field of a radiating polarized wave traveling in the third (positive z) direction, can be described by:

\vec{E}(t, z)=\vec{x}·Eₓ₀ cos(ωt−kz+φₓ)+\vec{y}·E_{y0} cos(ωt−kz+φ_{y})

where Ex0 is the maximum magnitude of the x component of the electric field, and Ey0 is the maximum magnitude of the y component of the electric field; ω is the radial frequency, ω=2πf; k is the propagation constant (also known as the phase constant, or wave number),

$$k = \frac{2 π}{λ} ;$$

z is the axis of electromagnetic wave propagation; and ΔΦ is the phase difference between the two components, Δφ=φ_{y}−φₓ.

As illustrated by FIG. 3, the ratio of the major axis to the minor axis is referred to as the axial ratio (AR), and it is equal to:

$$A R = \frac{O A}{O B} , 1 \leq A R \leq ∞ .$$

In the case of circular polarization,

Eₓ₀=E_{y0}; Δφ=φ_{y}−φₓ=±(½+2n)π, n=0, 1, 2, . . . ,

and AR is close to or equal to 1.

In order to design an antenna with an AR close to 1 (and to achieve other desired properties), the geometric dimensions of the antenna layout can be adjusted. For example, amplitude balance Eₓ₀=E_{y0} may be achieved by appropriate choices for the lengths of the antennas 5, 6, the sizes of the gaps between the antennas 5, 6 and the ground plane 3a, the width of the microstrip line section 9, and so on.

The phase balance Δφ=±(½+2n) π can then be adjusted by providing an additional phase-shift circuit that introduces a phase shift Δφ_{S}, as will now be described in more detail.

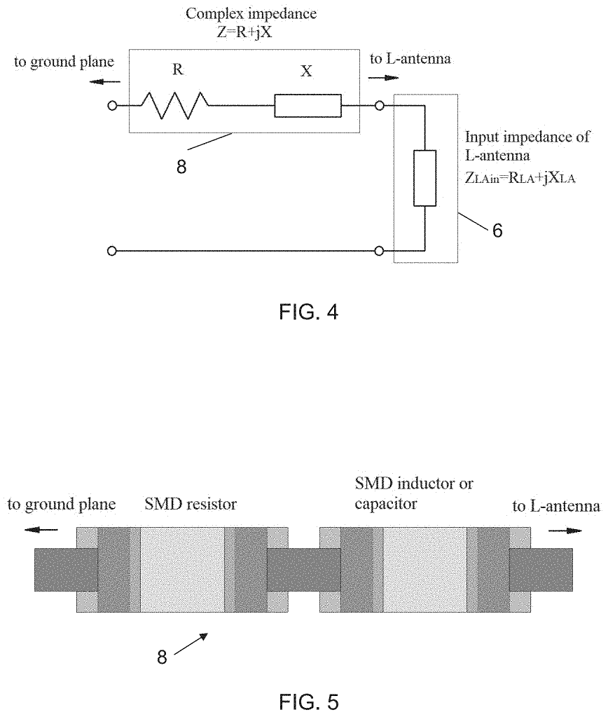

As illustrated by FIG. 4, a complex impedance may be provided by a resistor R connected in series with an inductor or a capacitor. The resistor provides the real part R of the complex impedance, and an inductor or a capacitor provides the imaginary part (the reactance X) of the complex impedance.

As illustrated by FIG. 5, the resistor may be an SMD (surface mounted device) resistor, the inductor may be an SMD inductor, and/or the capacitor may be an SMD capacitor.

Connecting the complex impedance Z to the input of the L-antenna (having input impedance Z_{LAin}=R_{LA}+jX_{LA}) forms a phase-shift circuit that introduces a phase shift Δφ_{S}.

In the case that an imaginary part X of the complex impedance Z is an inductance X_{L}, the phase shift is:

$${Δφ}_{S} = - arc h tan \frac{{X}_{L}}{{R}_{L A}} ,$$

and in the case that the imaginary part X of the complex impedance Z is a capacitance X_{C}, the phase shift is:

$${Δφ}_{S} = arc h tan \frac{{x}_{C}}{{R}_{L A}} ,$$

where R_{LA} is the real part of the input impedance of the inverted-L antenna.

Such a phase shifting circuit can introduce a fixed phase shift over a wide frequency range.

This approach offers a very compact layout because lumped elements typically are much smaller than delay lines. This is an important consideration for low frequency designs (i.e. below X-band), since delay transmission lines can be quite large. The real part R of the complex impedance X decreases the quality factor

$$Q = \frac{f}{Δ f}$$

of the phase shift circuit and increases the frequency bandwidth, since

$$Δ f = \frac{f}{Q} .$$

It will be understood that the electrical components 8 can be selected so as to control the amplitude and/or phase balance between the first antenna 5 and the second antenna 6. This in turn allows simultaneous control of the axial ratio, the antenna gain and the input impedance of the antenna.

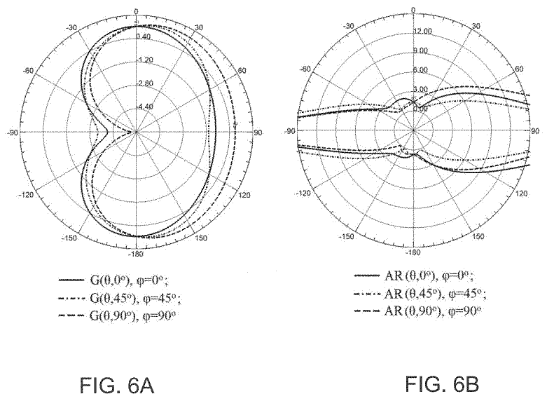

FIG. 6A illustrates the far field pattern G(θ,φ) of an antenna configured in accordance with an embodiment. A maximum gain of 1.5 dBi, and an efficiency of 85% are shown. It can also be seen that there are no deep zeroes (i.e. significant reduction of the antenna's gain) in the antenna's radiation characteristics.

FIG. 6B illustrates the axial ratio (AR) of an antenna configured in accordance with an embodiment. This figure demonstrates that the proposed antenna provides an AR lower than 3 dB in the θ angle range of 90° (θ from −60° to +30°) for φ=0° (XZ plane or the azimuth plane depending on antenna orientation relatively to the Earth's surface), which is satisfactory for various applications.

It will be appreciated that various embodiments provide an antenna configured to provide circular polarized electromagnetic radiation formed from an inverted-F antenna 5, and an additional inverted-L antenna 6 connected to the ground plane 3a through a microstrip line section 9 and serial complex impedance 8.

The inverted-F antenna 5 is the source of electromagnetic waves with a first linear polarization, and the inverted-L antenna 6 is the source of electromagnetic waves with a second linear polarization orthogonal to the first one. The input 7 of inverted-F antenna 5 is the input of the whole circularly polarized antenna.

The inverted-L antenna is connected to the ground plane 3a through the microstrip line section 9 and serial complex impedance 8. The microstrip line section 9 and the serial complex impedance 8, which connect the additional inverted-L antenna 6 to the ground plane 3a, are used to regulate the amplitude and phase balance between the two orthogonal radiating components, and to control the axial ratio, antenna gain and input impedance of the antenna.

The antenna is compact, and therefore especially useful for miniature sensors and handheld devices; low-cost; and has improved characteristics (axial ratio, gain, impedance matching) in comparison to conventional antennas.

What is claimed is:

1. A microstrip antenna configured to emit and/or receive elliptically or circularly polarized radiation, the microstrip antenna comprising:
a substrate;
a conductor arranged on a first side of the substrate; and
a ground plane;
wherein the conductor comprises a first antenna extending generally in a first direction, and a second antenna extending generally in a second direction, wherein the second direction is orthogonal to the first direction; and
wherein the second antenna is connected to the ground plane via one or more electrical components comprising one or more resistors, one or more inductors and/or one or more capacitors.

2. The antenna of claim 1, wherein the first antenna comprises a first monopole section extending along the first direction, and the second antenna comprises a second monopole section extending along the second direction.

3. The antenna of claim 1, wherein:
the first antenna comprises an inverted L-antenna or an inverted F-antenna; and/or
the second antenna comprises an inverted L-antenna or an inverted F-antenna.

4. The antenna of claim 1, wherein the first antenna comprises an inverted F-antenna.

5. The antenna of claim 1, wherein:
the first antenna comprises a first monopole section arranged along the first direction;
the first monopole section is connected to the ground plane by a first microstrip section at one end of the monopole section;
the first antenna comprises a second microstrip section connected to the first monopole section at an intermediate point on the monopole section; and
the antenna is fed by an input provided on the second microstrip section.

6. The antenna of claim 1, wherein the second antenna comprises an inverted L-antenna.

7. The antenna of claim 1, wherein the second antenna comprises a monopole section arranged along the second direction, and the second monopole section is connected to the ground plane by a microstrip section at one end of the monopole section.

8. The antenna of claim 7, wherein the monopole section of the second antenna is connected to the ground plane by a first microstrip line section extending in the first direction connected in series with a second microstrip line section extending in the second direction.

9. The antenna of claim 7, wherein the one or more electrical components are connected in series between the monopole section of the second antenna and the ground plane.

10. The antenna of claim 1, wherein the one or more electrical components form a phase shift circuit.

11. The antenna of claim 1, wherein the one or more electrical components comprise:
one or more resistors connected in series with one or more inductors; and/or one or more resistors connected in series with one or more capacitors.

12. The antenna of claim 1, wherein the one or more electrical components comprise one or more surface mounted electrical components.

13. The antenna of claim 1, wherein the first antenna comprises an inverted F-antenna and the second antenna comprises an inverted L-antenna.

14. The antenna of claim 1, wherein the second antenna comprises a monopole section arranged along the second direction, and the second monopole section is connected to the ground plane by a microstrip section at one end of the monopole section, and wherein the monopole section of the second antenna is connected to the ground plane by a first microstrip line section extending in the first direction connected in series with a second microstrip line section extending in the second direction.

15. A microstrip antenna configured to emit and/or receive elliptically or circularly polarized radiation, the microstrip antenna comprising:
a substrate;
a conductor arranged on a first side of the substrate; and
a ground plane;
wherein the conductor comprises a first antenna extending generally in a first direction, and a second antenna extending generally in a second direction, wherein the second direction is orthogonal to the first direction;
wherein the second antenna is connected to the ground plane via one or more electrical components comprising one or more resistors, one or more inductors and/or one or more capacitors; and
wherein the first antenna comprises an inverted F-antenna and the second antenna comprises an inverted L-antenna.

16. A microstrip antenna configured to emit and/or receive elliptically or circularly polarized radiation, the microstrip antenna comprising:
a substrate;
a conductor arranged on a first side of the substrate; and
a ground plane;
wherein the conductor comprises a first antenna extending generally in a first direction, and a second antenna extending generally in a second direction, wherein the second direction is orthogonal to the first direction;
wherein the second antenna is connected to the ground plane via one or more electrical components comprising one or more resistors, one or more inductors and/or one or more capacitors; and
wherein the second antenna comprises a monopole section arranged along the second direction, and the second monopole section is connected to the ground plane by a microstrip section at one end of the monopole section, and wherein the monopole section of the second antenna is connected to the ground plane by a first microstrip line section extending in the first direction connected in series with a second microstrip line section extending in the second direction.
